(19) United States
(12) Patent Application Publication
(10) Pub. No.: US 2012/0281000 A1
(43) Pub. Date: Nov. 8, 2012

(54) WI-FI SENSOR

(75) Inventor: Ryan Winfield Woodings, Boise, ID (US)

(73) Assignee: MetaGeek, LLC, Boise, ID (US)

(21) Appl. No.: 13/552,449

(22) Filed: Jul. 18, 2012

Related U.S. Application Data
(63) Continuation of application No. 12/478,568, filed on Jun. 4, 2009, now abandoned.
(60) Provisional application No. 61/058,845, filed on Jun. 4, 2008.

(51) Int. Cl. G06T 11/20

(52) U.S. Cl. 345/440

(57) ABSTRACT

Disclosed is a combined spectrum and channel analyzer with output in the form of various graphical displays. The graphical displays can be configured to display frequency, amplitude, time and density via a spectral view, a topographic view, or a planar view, or combinations of those views. Channel activities, parameters, overlap and interaction are shown in the displays.

### PRIORITY/CROSS-REFERENCE TO RELATED APPLICATIONS

This application claims the priority date of the provisional application entitled WI-FI SENSOR filed by RYAN WINFIELD WOODINGS on Jun. 4, 2008 with application Ser. No. 61/058,845, the disclosure of which is incorporated by reference.

### FIELD OF THE INVENTION

The invention generally relates to an apparatus for analyzing a spectrum of radio frequencies, and more particularly to analyze the Wi-Fi spectrum.

### BACKGROUND OF THE INVENTION

IEEE 802.11, also known as Wi-Fi, is a wireless local area network (WLAN) technology commonly used for networking computers, together. Wi-Fi can operate in either the 2.4 GHZ Industrial Scientific Medical (ISM) band, or in the 5 GHz band. Due to frequency constraints in the 2.4 GHz ISM band, Wi-Fi channels overlap each other. If a Wi-Fi network is operating on channel 3, its transmissions will overlap transmissions on channels 1, 2, 4, 5, 6, and 7.

Wi-Fi scanners, such as Netstumbler gather information about nearby Wi-Fi networks. This information typically includes: MAC Address, SSID (network name), channel, signal-to-noise-ratio, network type, and network security details. This information is then displayed, usually in a table format.

The table format doesn't show overlap caused by Wi-Fi networks on neighboring channels, nor does it help the user to visually understand interaction between the various networks. In other words, by only showing the Wi-Fi channel being used by each network, Wi-Fi scanners fail to convey the physical layer information from the user. The table format doesn't show the user channel overlap.

Spectrum analyzers are devices that display the power spectrum over a given frequency in real-time. Some spectrum analyzers are large hardware devices, such as the HP 8561. Some lower-cost spectrum analyzers focus on a specific frequency band and use a combination of specialized hardware and software, such as Chanalyzer from MetaGeek. Spectrum analyzers are focused on the physical radio frequency signals and are protocol-agnostic.

Experienced spectrum analyzer users will be able to identify Wi-Fi signals due to their unique shape. For example, 802.11b signals will show up as a 22 MHz wide arch. Experienced users can, therefore, determine what channels have active Wi-Fi networks, but they cannot determine what networks are active from the spectrum analyzer display alone.

What is needed is a Wi-Fi scanner which displays in a graphical manner the channel activities and interactions of various frequencies.

### SUMMARY OF THE INVENTION

The Wi-Fi scanner of the invention shows the networks in a frequency/amplitude graph based on the channel and signal-to-noise ratio, and other network information. The amount of network traffic may also be displayed. In one embodiment of the invention, increased traffic is shown by line variations, such as increased line thickness. Line thickness, darkness, and transparency are three possible implementations of this concept. Another optional feature of the invention is to visually display other network parameters. For example, secure networks could be drawn with solid lines and unsecured networks could be drawn with dashed lines.

The device of the invention is a Wi-Fi detection instrument which includes a Wi-Fi scanner for detecting Wi-Fi signals and parameters at the location in the vicinity of the scanner. The device includes a visual display device for displaying a graphical depiction of detected parameters of the adjacent Wi-Fi network. Parameters can include frequency and amplitude of each network frequency which is detected. Another parameter which the Wi-Fi detection instrument is capable of displaying is a graphic representation of the traffic on each of the Wi-Fi networks which are detected. Along with detecting each Wi-Fi network in the vicinity, the Wi-Fi scanner is configured to detect and display security features of each Wi-Fi network such as may be designated by dashed or solid lines, different colors of lines, or line thickness.

Signal parameters may also be displayed such as MAC address, SSID (network name), channel, signal-to-noise-ratio, network type and network security. The device is configured to display each of these parameters in a graphical representation showing multiple channels on the same graphic.

Parameters displayed can include one or more frequency/amplitude graphs, with the graphs including information relating to one or more signal parameters including channel signal to noise ratio, traffic volume, network security features, and other signal information such as vender, IP address and subnet.

The Wi-Fi detection instrument of the invention has a capability of displaying frequency information in real time with the parameters and the spectrum information both displayed in a graphic display.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a diagram showing the device of the invention in use.

FIG. 2 is a diagram showing frequency and amplitude of each network frequency detected, with overlap between channels.

FIG. 3 is a table showing Wi-Fi network parameters.

FIG. 4 is a front view of a prior art spectrum analyzer.

FIG. 5 is a screen view showing a topographic and a planar display of network parameters.

FIG. 6 is a screen view showing parameters of 4 detected networks.

FIG. 7 is a screen view showing a topographic and a spectral display of network parameters.

FIG. 8 is a screen view showing a topographic and a planar display of network parameters, with current, average and maximum amplitudes.

FIG. 9 is a screen view in the form of a bar graph showing current, average and maximum amplitudes

FIG. 10 is a screen view in the form of line graphs showing amplitude of detected networks.

FIG. 11 is a screen view in the form of a line graph showing RSS over time.

FIG. 12 is a table showing the parameters of detected networks.

FIG. 13 is table showing parameters of detected networks.

FIG. 14 is a screen view showing real time power spectrum, with graphic display of parameters.

FIG. 15 is a screen view of spectral, topographic, and planar views of graphically displayed network parameters.

FIG. 16 is a diagram of the components of the device of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

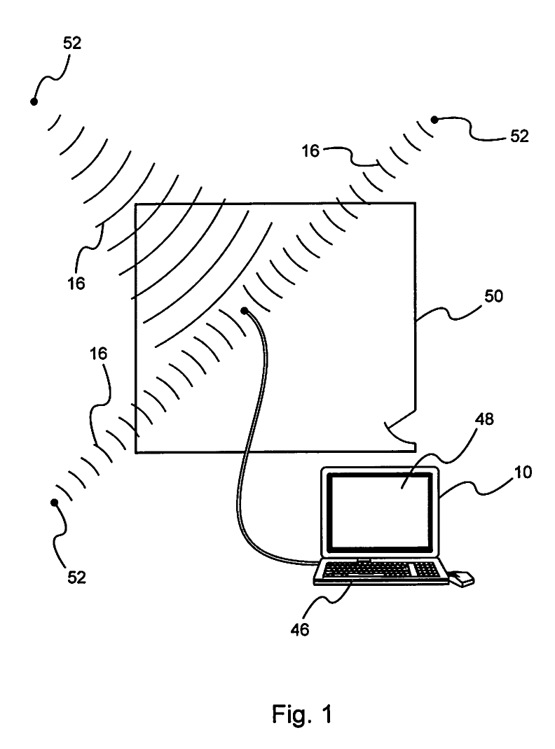

FIG. 1 shows the Wi-Fi detection instrument 10 of the invention located in a room 50 and activated to detect any Wi-Fi signals 16 which are present. As shown in FIG. 1, each of these Wi-Fi signals can be a different strengths as well as having a number of other different parameters. The different strengths of the Wi-Fi signals 16 are shown by the different size of the arc representing the signal. The Wi-Fi detection instrument 10 of the invention includes an input device such as a keyboard 46 a graphical display 48. In use, the Wi-Fi detection instrument of the invention 10 would be activated, and from its location in the room 50 would detect any detectable Wi-Fi signal 17 which emanate from a Wi-Fi signal source 52.

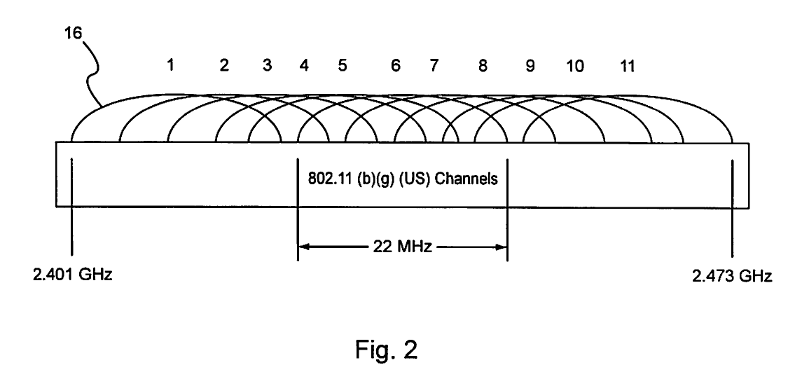

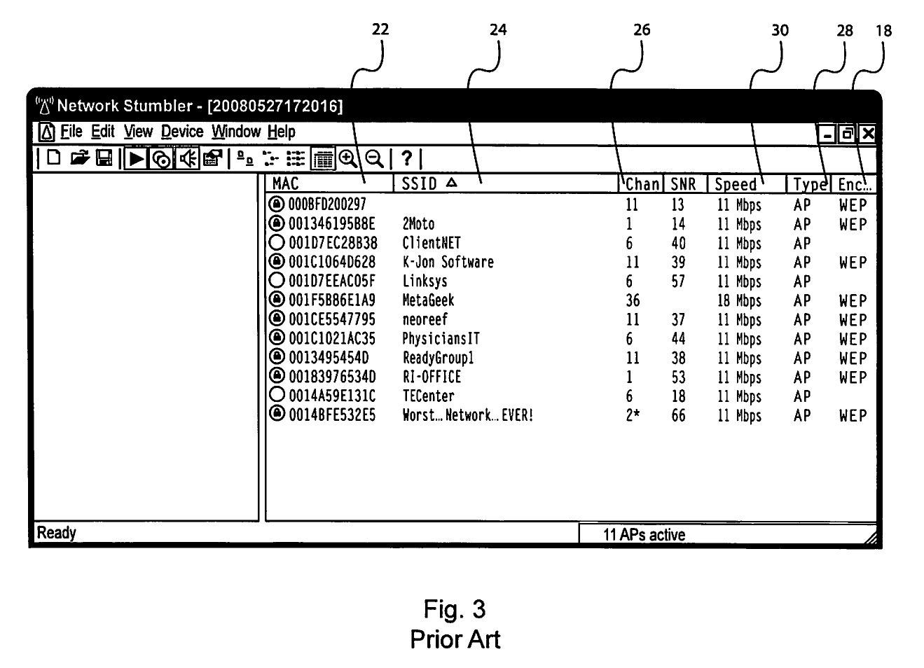

FIG. 2 is a graphic which shows the overlap of a number of Wi-Fi channels, and the characteristic overlap of channels 1, 2, 4, 5, 6 and 7 over a Wi-Fi network operating on channel 3. FIG. 3 shows Wi-Fi parameters shown in table format, with MAC address 22 SSID (network channel) 24 channel 26 speed 30 network type 28 and incription information 18. This depiction would be typical of certain prior art Wi-Fi scanners such as Net Stumbler. As noted above, the table format does not show the overlap of the different Wi-Fi networks nor does it help the user to visually understand the interaction between the various networks.

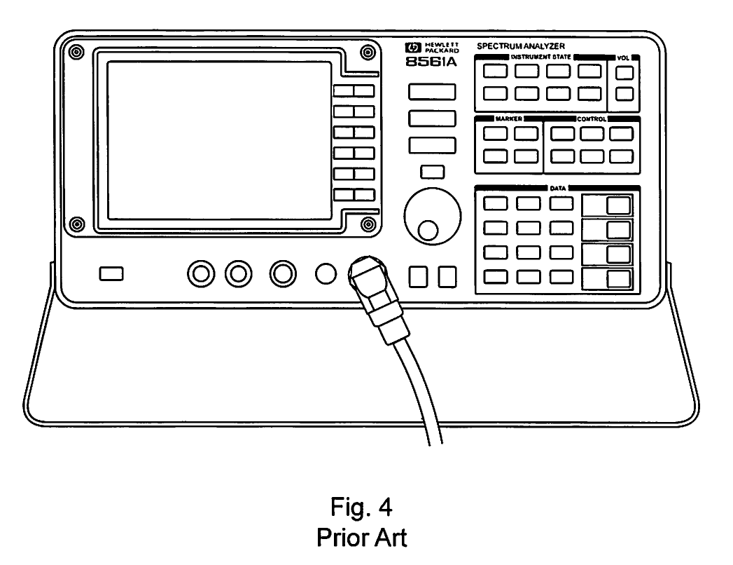

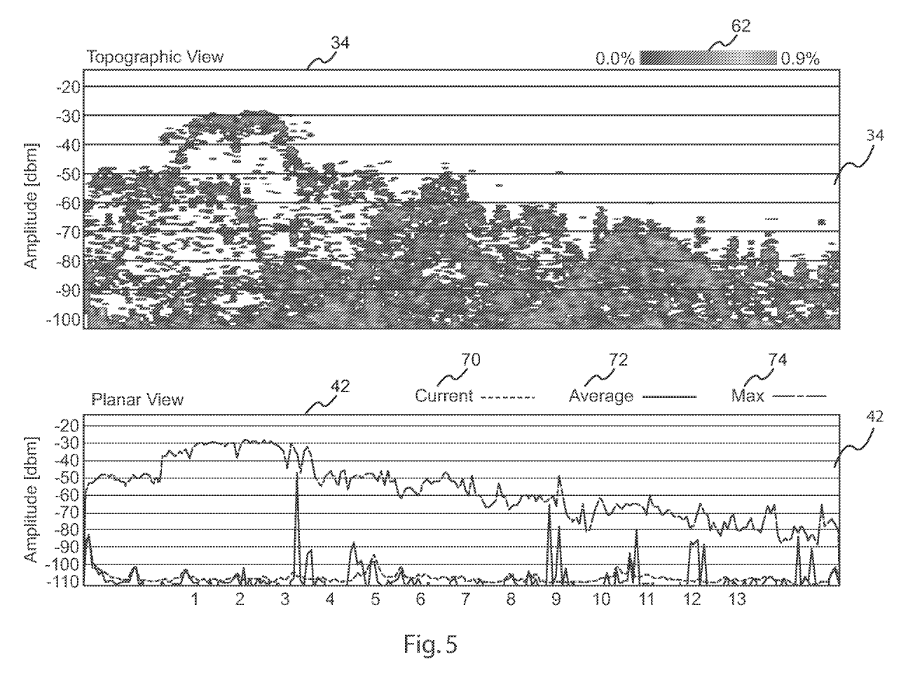

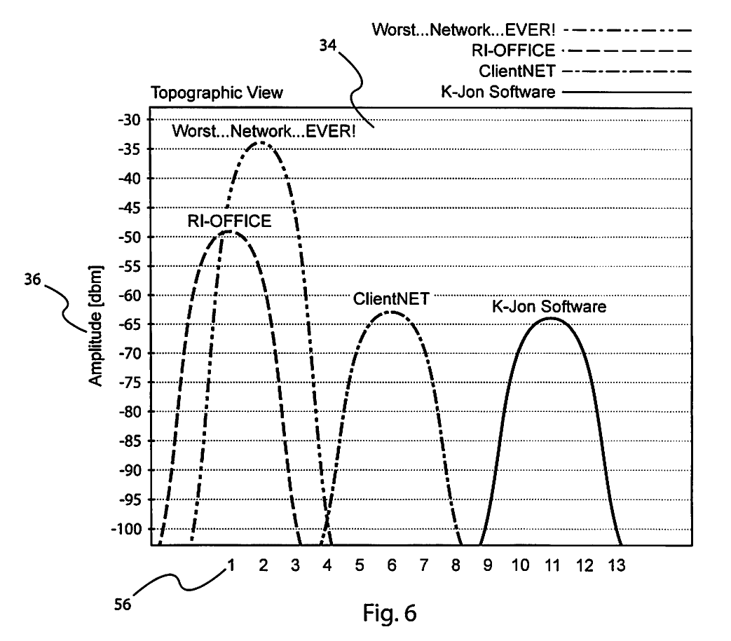

FIG. 3 is a front view of a prior art spectrum analyzer. The spectrum analyzer such as shown in FIG. 4 would typically utilize software such as Chanalyzer software, with an output such as what is shown in FIG. 5. This is a topographic view and a planar view of networks detected on the system. A problem with this view is that even experienced users would be unable to determine what networks are active from the spectrum analyzer display alone. FIG. 6 shows one view of a preferred embodiment of the Wi-Fi scanner 10 of the invention. Shown in FIG. 5 is a topographic view which graphs the amplitude 36 and frequency 56 of four separate Wi-Fi networks which are detected at the time of the sampling. This figure shows the popularity (frequency/amplitude density) of each frequency/amplitude coordinate during the time displayed. A high popularity could be indicated by a different color, such as red. The curved designated “Worst Network Ever” would be in red, with the RI-Office being green, the ClientNET being yellow, and the K-Jon Software being colored in a light green. Increased line traffic is preferably shown by line variations such as line thickness, darkness, and patters such as dotted, dashed and solid. The topographic view contains a legend 62 which defines the meaning of colors. Colors can be designated as blue being a low and red being a high popularity.

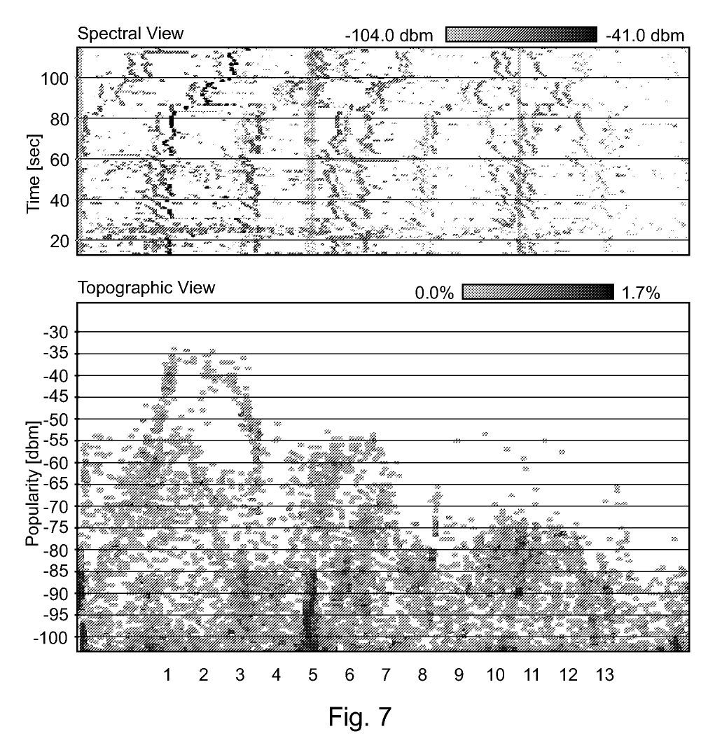

FIG. 7 shows a spectral view 32 as well as a topographic view 34. The spectral view includes a waterfall graph that shows the amplitude over time for each frequency. A horizontal row 60 is added to the spectral view at predetermined time intervals with updated information about amplitude of each detected network. It is desirable to have the waterfall graph use colors to make the data more meaningful. Dark blue can represent low amplitudes and bright red can represent high amplitudes, and a legend 62 is provided to indicate definitions of the meaning of colors.

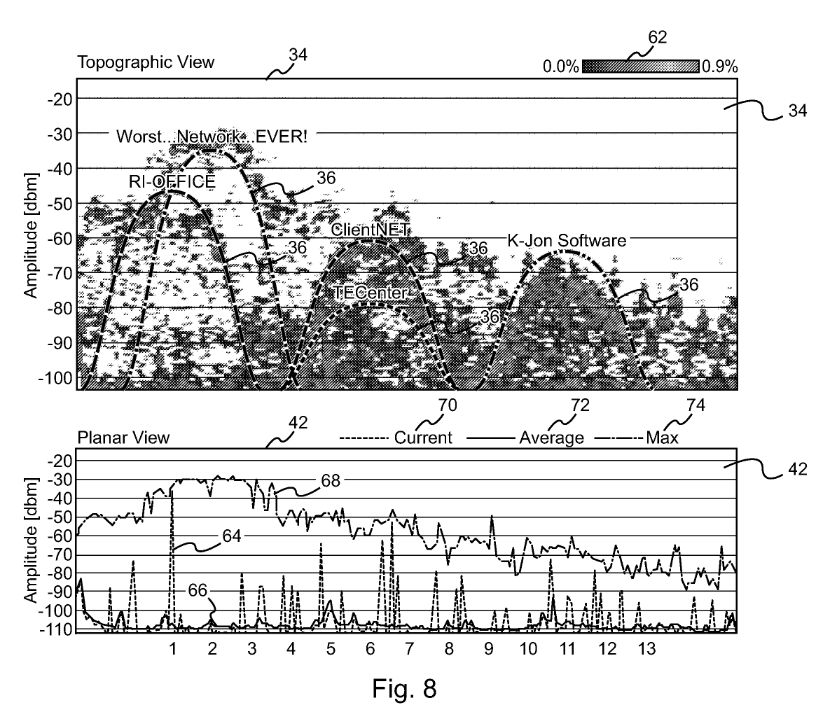

FIG. 8 shows a display in which a topographic view 34 is displayed alongside a planar view 42. The planar view shows typical amplitude over frequency display. In this graph colors can be utilized to better understand the data that is displayed. For instance, a yellow line 64 shows the current amplitude of each frequency, a green line shows the average amplitude 55, and a blue line 68 can show the maximum amplitude. Provided in the planar view are labels for current 70 average 72 and maximum 74, when each of these are activated toggles to a display of the corresponding trace. An alternate mechanism for toggling can be using the keys Ctrl/Alt M, A, or C to turn off or on the max, average or current display.

The topographic 34 shown in FIG. 8 shows the amplitude 36 of the five networks detected. The presence of different line patterns such as solid dashed and dotted can be used to indicate incription or the lack of. For instance the dotted line shown in the topographic view of FIG. 8 can indicated a network that contains no incription. The solid line can indicate a network in which incription is present.

FIG. 8 is a bar graph showing the current, maximum and average level of traffic on each of the networks detected. Shown are the current level 70, the average level 72, and the maximum level 74.

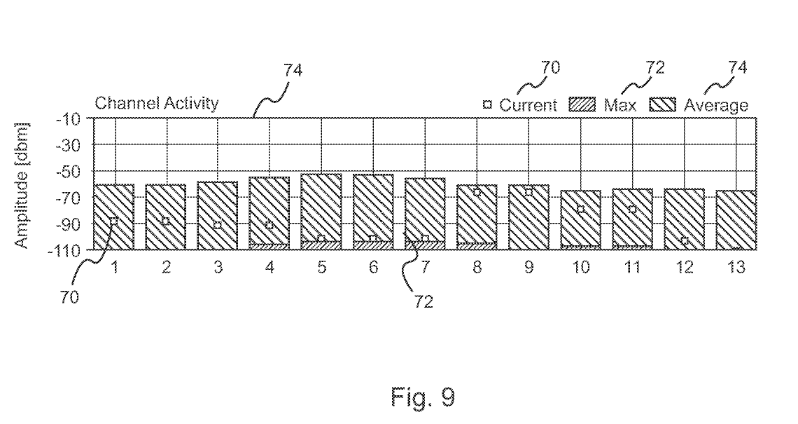

FIG. 9 is a line graph which shows channel activity over time. Each of the lines in specific to a particular channel, and can be identified by color which is indicated in the legend 62.

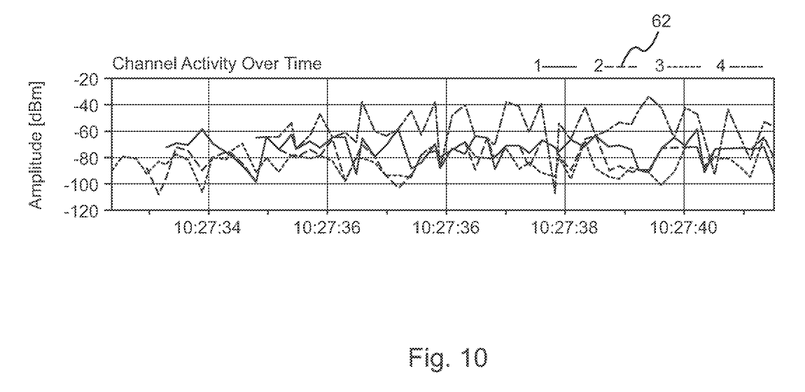

FIG. 10 shows the amplitude of each channel (identified in the legend 62) over time. The amplitude of a channel is calculated based on the amplitude of all measurements for that channel. The channel depiction can be based on maximum, average, or minimum amplitudes.

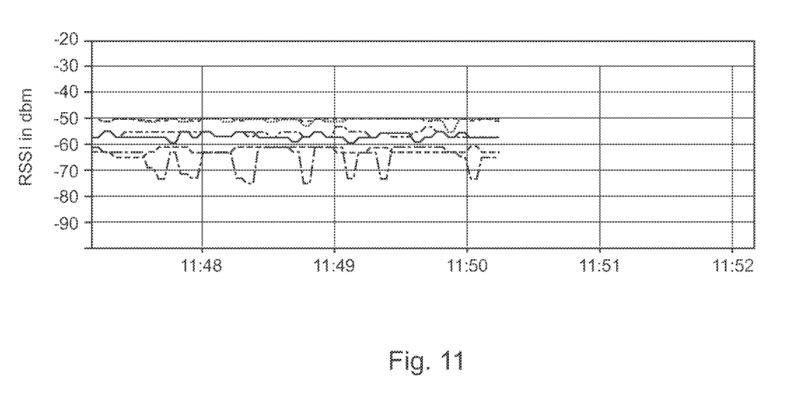

FIG. 11 shows the amplitude of each channel in terms of RSSI. (could use more input from you expert guys).

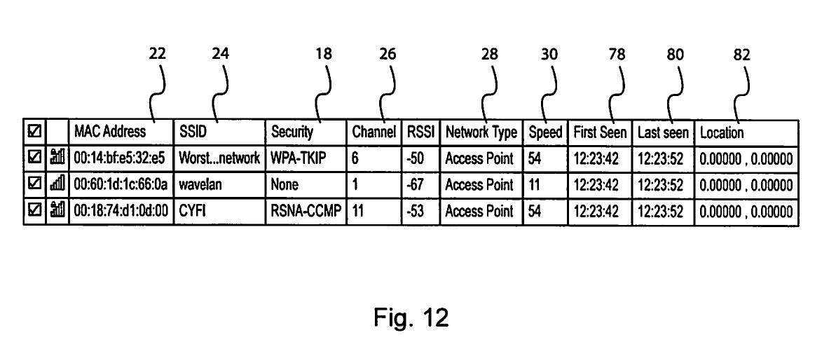

FIG. 12 is a table which shows such Wi-Fi channel parameters as MAC address 22, SSID 24, security 18, the channel 26, and the RSSI 76. Other parameters can be displayed such as this including network type 28, speed 30, the time at which it is first seen 78, the time last seen 80, and the location at which the readings are taken 82.

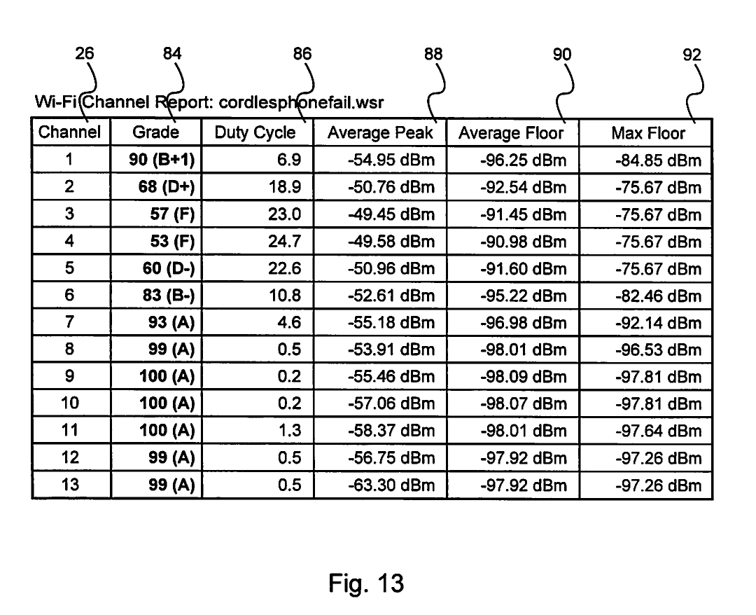

FIG. 13 shows a table which displays the Wi-Fi channel report. This includes information about the channel 26, the grade 84, the duty cycle 86, the average peak 88, the average floor 90, and the maximum floor 92. The grade 84 shows a numerical value which indicates the relative “quietness” of a channel, or how good a fit that channel is for another Wi-Fi network. This is used to determine what channel to install a new network on. The alpha grade is a quality ranking, with A being the best rating. The duty cycle 86 is a numerical value which represents the level of radio frequency activity on that channel. The average peak represents the maximum amplitude of any frequency within that channel. Floor is the noise floor.

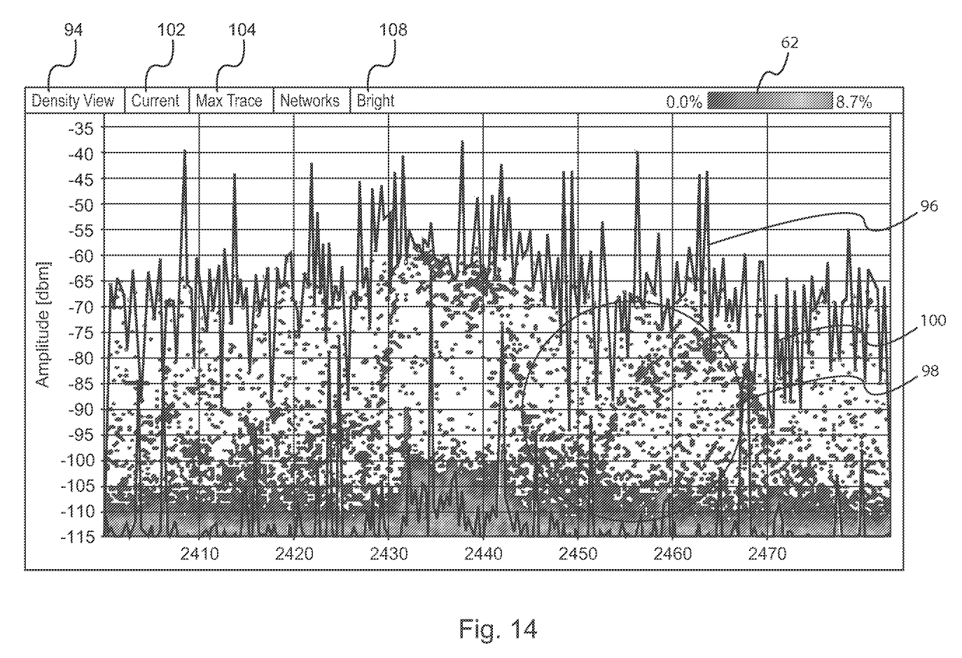

FIG. 14 is a type of graph which shows a density view 94. The density view 94 is a display of the real time power spectrum with a graphic display of parameters. A legend 62 is provided to define the meaning of color. The line shown at 96 indicates max amplitude as described previously in planar view. Region 98 is the same as the Topographic View described earlier. The graph shown in FIG. 14 would typically be colored, and have patches of color in the region 98, with the patches of color patches of color indicating for example, red indicating a high density (that frequency/amplitude point has a lot of measurements), yellow being medium density blue representing low (as shown in the color palette legend). When the “current” button is selected the current amplitude trace (from the planar view description) is displayed. When the “max trace” button is selected the maximum amplitude is displayed. When the networks button is selected the network overlays are drawn from the network scanner information.

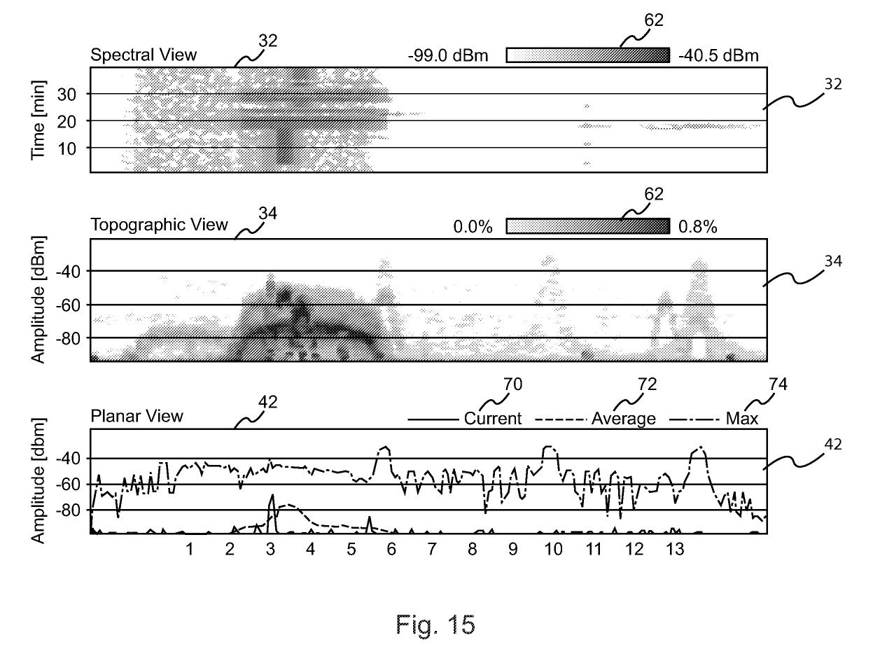

FIG. 15 is a single view screen with a spectral view 32, a topographic view 34, and a planar view 42 all shown on the same screen. These three graphs have features which have been described in the previous text.

The preferred embodiment of the invention includes three views, a spectral view, a topographical view, and a planar view. These views may be viewed with all three together on a screen or window, as two windows on a screen, or as one view at a time on a screen.

The Spectral View contains a waterfall graph that shows amplitude over time for each frequency. Based on the timeframe a row is added to the Spectral View every X seconds or minutes. The color of each frequency/time coordinate represents the amplitude of that frequency, with dark blue representing low amplitudes and bright red representing high amplitudes as shown in the legend.

The Topographic View contains an amplitude over frequency graph similar to the Planar View, but instead of showing the current amplitude of each frequency, it shows the popularity of each frequency/amplitude coordinate during the time displayed. The coloration of the Topographic View is similar to the Spectral View with blue being low and red being high, but the coloration now represents the “popularity” instead of the amplitude.

Planar View shows a typical amplitude over frequency display. The yellow line shows the current amplitude, the green shows the average amplitude, and the blue shows the maximum amplitude. Click the Current, Average, and Max labels in the Planar View controls to toggle the display of the corresponding trace. You can also press CTRL ALT M, A, or C to turn off the Max, Average, or Current display.

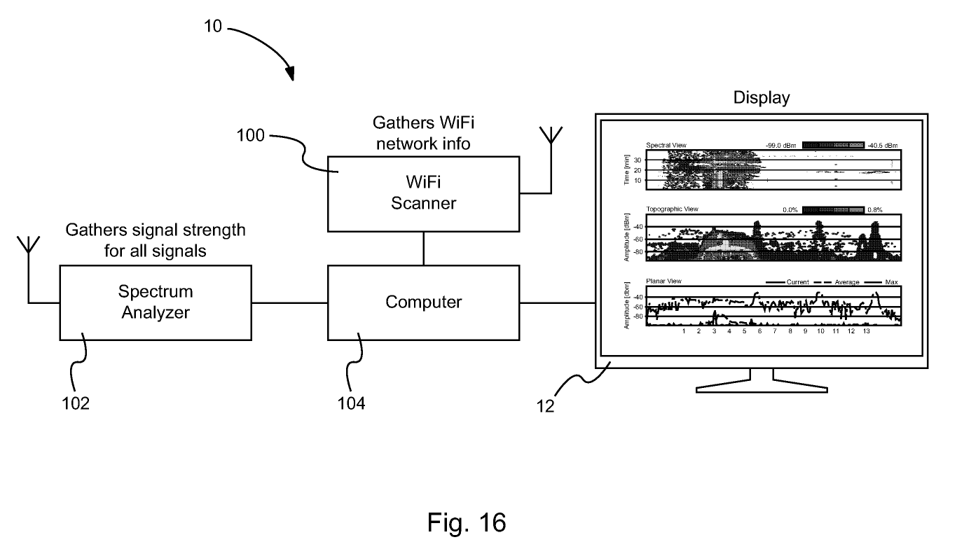

FIG. 16 shows the Wi-Fi scanner 100 and the spectrum analyzer 102 of the invention. They are connected to a computer 104, which combines information detected by each and displays the information in graphical form in the visual display device 12. The integration of Wi-Fi scanner information with a spectrum analyzer creates the possibility to display both the network information and the spectrum analyzer information in the same display. This allows the user to see all key network information in a single display. A Wi-Fi scanner uses a Wi-Fi radio to either actively ping Wi-Fi devices for information or passively listen to Wi-Fi data for information. It only collects information based on the Wi-Fi packets it hears.

A spectrum analyzer measures the amplitude of all radio activity, whether it is from Wi-Fi or other devices. This is NOT reading the packets, it is strictly measuring the strength of the transmissions. In the past, these two devices were separate, with separate user interfaces and displays. This meant that it was easy to gather information about all Wi-Fi networks in the area, but difficult to see how the Wi-Fi networks related to any other signals that may or may not be interfering with the Wi-Fi. Also, there wasn't the frequency/amplitude display of the Wi-Fi network information showing the overlap between networks due to being on the same or neighboring channels.

Spectrum analyzers show the signal strengths, and an experienced user can easily identify signals from Wi-Fi networks due to their frequency/amplitude shape, but had no information about the Wi-Fi networks themselves (such as name, security type, etc). By combining the displays of the spectrum analyzer and Wi-Fi scanner we have brought all the information together AND added the frequency/amplitude display of the Wi-Fi networks. The result is a tool that shows interaction between Wi-Fi networks AND interaction between Wi-Fi and other wireless signals.

The preferred spectrum analyzer 102 of the invention is Wi-Spy, made by MetaGeek. It is hardware and the software provides the function of combining the data from the spectrum analyzer and the Wi-Fi scanner, which can be a single piece of software in the invention, to create the invention.

The Wi-Fi scanner uses either a built-in Wi-Fi radio in the laptop or an off-the-shelf Wi-Fi adapter for the hardware and the software just controls the radio to listen for Wi-Fi data.

One possible implementation is to use the channel and signal-to-noise ratio information from the Wi-Fi scanner to draw the shape of the Wi-Fi signal onto the spectrum analyzer display. An example of this is shown in FIG. 8. This display may or may not include labeling the networks and/or including other network information (encryption, network type, etc.) in the spectrum analyzer view. By overlaying the image of the V network on top of the spectrum analyzer display, the user is able to visually see the physical relationship between Wi-Fi networks.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1.-14. (canceled)

15. A wireless network detection instrument comprising:
a wireless signal scanner for detecting wireless signals and parameters from multiple wireless signal sources, the wireless signal scanner configured to detect and display a graphic depicting a security feature of said detected wireless network;
at least one spectrum analyzer detecting real time power spectrum information from wireless signal sources at a selected location; and
a visual display device for displaying a graphic simultaneous depiction of detected wireless network information from said wireless signal scanner and detected real time power spectrum information from said at least one spectrum analyzer, including one or more characteristics of the detected wireless network, the visual display device further displaying at least a one of a spectral view, a topographical view, or a planar view of the detected wireless network overlayed with said real time power spectrum information and a visual indication differentiating between a network level of traffic for each of said detected wireless signals and a visual indication differentiating between at least two detected network parameter parameters for each of said detected wireless signals, the visual display device further configured to display each of the at least one network parameters in a graphical representation showing multiple channels on the same graphic.

16. The wireless network detection instrument of claim 15, wherein said wireless signal scanner is configured to detect and display a graphic depicting a security feature of said detected wireless network.

17. The wireless network detection instrument of claim 15, wherein said wireless signal scanner is configured to detect one or more signal parameters selected from the list comprising MAC address, SSID (network name), channel, signal-to-noise ratio, network type, and network security.

18. The wireless network detection instrument of claim 15, wherein said parameters displayed include one or more frequency/amplitude graphs, with said graphs including information relating to one or more signal parameters selected from the list comprising channel signal-to-noise ratio, traffic volume, network security features, and other signal information such as vendor, IP address, and subnet.

19. The wireless network detection instrument of claim 15, wherein said visual display device provides a visual differentiation for each characteristic of said detected wireless network information, the visual differentiation including line thickness, line color, line style, fill or no fill, fill color, dot size, shading density, shading color, and other graphic representations of parameter differences.

20. The wireless network detection instrument of claim 19, wherein information is displayed in the form of line, bar, pie, scatter plot, area, histograms, high low tolerance graphs, Pareto distribution, Venn diagrams, stacked line graph, wave plots, median graph, series/parallel graphs, or other graphic displays.

21. The wireless network detection instrument of claim 19, further including a wireless spectrum analyzer, and wherein said visual display device is configured to display wireless signal scanner information in table form along with a graphical representation of wireless spectrum analyzer data.

22. The wireless network detection instrument of claim 21, which further comprises a spectrum analyzer, with said spectrum analyzer configured to detect parameters of a power spectrum of a selected frequency in real time, with said spectrum analyzer information display on said visual display device with said wireless signal scanner information to result in a graphic display of both sets of data.

23. The wireless network detection instrument of claim 15, wherein said visual display provides a separate visual indication representing a popularity of a detected wireless network.

24. The wireless network detection instrument of claim 23, wherein said separate visual indication representing a popularity of a detected wireless network is a color.

25. The wireless network detection instrument of claim 23, wherein said separate visual indication representing a popularity of a detected wireless network is a line thickness.

26. The wireless network detection instrument of claim 23, wherein said visual display device is configured to provide a plurality of labels representing detected wireless network parameters, each the plurality of labels including an activate toggle to display a corresponding trace of the detected wireless network parameter.

27. The wireless network detection instrument of claim 23, wherein said visual display device provides a table displaying the wireless channel report further including a quality ranking associated with one or more of the detected wireless networks.

28. A method for detecting a wireless network comprising:
detecting wireless signals and parameters from multiple wireless signal sources via a wireless signal scanner for, the wireless signal scanner configured to detect and display a graphic depicting a security feature of said detected wireless network;
detecting real time power spectrum information from wireless signal sources at a selected location via at least one spectrum analyzer; and
displaying a graphic simultaneous depiction of detected wireless network information from said wireless signal scanner and detected real time power spectrum information from said at least one spectrum analyzer via a visual display device, including one or more characteristics of the detected wireless network, the visual display device further displaying at least a one of a spectral view, a topographical view, or a planar view of the detected wireless network overlayed with said real time power spectrum information and a visual indication differentiating between a network level of traffic for each of said detected wireless signals and a visual indication differentiating between at least two detected network parameter parameters for each of said detected wireless signals, the visual display device further configured to display each of the at least one network parameters in a graphical representation showing multiple channels on the same graphic.

29. The method of claim 28, wherein said detecting wireless signals and parameters includes detecting and displaying a graphic depicting a security feature of said detected wireless network.

30. The method of claim 28, wherein said detecting wireless signals and parameters includes detecting one or more signal parameters selected from the list comprising MAC address, SSID (network name), channel, signal-to-noise ratio, network type, and network security.

31. The method of claim 28, wherein said displayed parameters include one or more frequency/amplitude graphs, with said graphs including information relating to one or more signal parameters selected from the list comprising channel signal-to-noise ratio, traffic volume, network security features, and other signal information such as vendor, IP address, and subnet.

32. The method of claim 28, wherein said displaying includes displaying a visual differentiation for each characteristic of said detected wireless network information, the visual differentiation including line thickness, line color, line style, fill or no fill, fill color, dot size, shading density, shading color, and other graphic representations of parameter differences, further including displaying a separate visual indication representing a popularity of a detected wireless network, wherein said separate visual indication representing a popularity of a detected wireless network is a color, said separate visual indication representing a popularity of a detected wireless network is a line thickness, and said visual display device is configured to provide a plurality of labels representing detected wireless network parameters, each the plurality of labels including an activate toggle to display a corresponding trace of the detected wireless network parameter.

33. The method of claim 32, wherein said displaying includes displaying wireless network information in the form of line, bar, pie, scatter plot, area, histograms, high low tolerance graphs, Pareto distribution, Venn diagrams, stacked line graph, wave plots, median graph, series/parallel graphs, or other graphic displays.

34. The method of claim 32, further including displaying wireless signal scanner information in table form along with a graphical representation of wireless spectrum analyzer data and visually displaying a wireless channel report further including a quality ranking associated with one or more of the detected wireless networks.
